(19) United States
(12) Patent Application Publication
(10) Pub. No.: US 2004/0210475 A1
(43) Pub. Date: Oct. 21, 2004

(54) Variable compensation tool and system for customer service agents

(76) Inventors: S. Renee Starnes, Tucson, AZ (US); Robert B. Squire, Tucson, AZ (US)

Correspondence Address: FENWICK & WEST LLP, SILICON VALLEY CENTER, 801 CALIFORNIA STREET, MOUNTAIN VIEW, CA, 94041, US

(21) Appl. No.: 10/714,496

(22) Filed: Nov. 14, 2003

Related U.S. Application Data
(60) Provisional application No. 60/429,369, filed on Nov. 25, 2002.

(51) Int. Cl. G06F 17/60

(52) U.S. Cl. 705/11

(57) ABSTRACT

A software tool for determining variable compensation for customer service agents is provided. The current variable compensation level is presented to agents in real time, based on each agent's performance relative to a cohort including the agent. The agents may also easily determine variable compensation levels based on hypothetical performance levels by direct manipulation of the user interface of the software tool.

### RELATED APPLICATION

This application claims the benefit of under U.S.C. section 119(e) from U.S. Patent Application serial No. 60/429,369, entitled “Variable Compensation Tool and System for Customer Service agents,” filed Nov. 25, 2002, which is incorporated by reference in its entirety.

### BACKGROUND

1. Field of the Invention

This invention relates generally software tools used in call centers to assist customer service agents and more particularly, to a software tool for providing performance feedback and incentive information to customer service agents in real time.

2. Background of the Invention

Businesses use call centers to provide their customers with information and assistance with their questions, comments, accounts and other needs. Call center operations have a significant impact on the customers' perceptions of the quality of the business, and thus a customer's satisfaction with the handling of their call is vital. The customer service agent thus plays a critical role in ensuring a satisfied customer. Customer service agents are sometimes compensated based on their skill level (as measured by in personal observation by supervisors), rate of handling calls, and other subjective or objective performance factors. Call centers that handle more customers per hour can improve overall customer satisfaction by decreasing the average amount of time of customers wait on hold, and the amount of time it takes to service their needs.

However, ensuring the proper balance of factors that lead to both improved agent performance and improved quality of service is a difficult task. For example, merely increasing the agent's rate of call handling (calls taken per hour) is likely to decrease the level of attention given to each call, and reduce overall customer satisfaction. On the other hand, increasing the amount of time taken by the agent to concentrate on the customer's needs, while improving the customer's satisfaction, results in overall fewer calls handled by the call center, and thus longer wait times by most customers to be serviced, and also generally reduces overall satisfaction. Further, the agent's ability to understand the relationship between their performance in objective terms and their ultimate compensation is typically not addressed by the software and other mechanisms call center agents use in their jobs. Thus, even though an agent may understand that some change in their performance is desirable, they typically do not have real time information that allows them to objectively determine which changes in their behaviors are most desirable.

It is thus desirable to provide a software-based tool that allows customer service agents to monitor their performance in handling customer calls, so as to assist agents in improving their performance, and ultimately reward employees for there superior service.

### SUMMARY OF THE INVENTION

The present invention provides a software based tool that provides agents with real time information about their performance in a manner that shows the relationship between their objective performance factors and their compensation, and that allows them to model or estimate potential compensation based on specific, measurable changes in such performance. The software tools, referred throughout this disclosure as “STARS,” work with a variable compensation program that varies the amount of compensation an agent receives based on their performance. STARS enables an agent to specifically determine their current level of compensation based on their current performance measurements, and to determine their potential compensation based on current performance measurement trends.

In a preferred embodiment, the STARS tool provides an agent with an interface that shows the agent's current performance with respect to various objective measures of performance, including combinations of:

a customer satisfaction score, describing the agent's performance in satisfying the customer's needs;

a call resolution score, describing the percentage of calls resolved by the agent;

a contacts per hour rate (CPH), describing the average number of calls the agent handles per hour, both in raw and percentile measures;

a transfer rate, describing the agent's rate for transferring callers;

a schedule compliance factor, describing the degree to which the agent complies with their specified work schedule; and

an adjusted call resolution rate (ACR), derived from the transfer rate and the call resolution score (both in raw and percentile measures), describing the agent's call resolution skills in light of the overall rate at which the agent allows customers to judge his skills.

In order to provide incentives to agents to continually improve their performance, percentile ranking of both CPH and ACR is used. Thus, a superior agent who maintains a high level of performance relative to his peers, is compensated more highly. Further, STARS recognizes that improved customer service by agents is based on a combination of both increased call handling rates (as reflected in CPH), and increased overall resolution of calls (as reflected by ACR). Thus, the tool operates to show to agents how their compensation is based on a combination of both of these objective measures. Improving on both measures simultaneously is the key to maximizing compensation. Accordingly, the interface of the STARS tool further provides information that shows how the combination of the agent's CPH ranking and ACR ranking determine the agent's current variable compensation payout, a sum to be received at the end of a selected period (e.g., quarterly) based on the agent's performance. Additionally, the performance metrics and hurdles can be changed to encourage a different employee behavior or outcome. The tool is designed to flex with the changing needs of the business.

Finally, the software tool enables the agent to determine precisely how much his compensation can be improved by improving his performance. Specifically, STARS provides an interface that allows the agent to interactively model (e.g. improve) their anticipated CPH or ACR, and observe the precise amount of payout they would receive from such improved performance. This allows the agent to set personal goals for these factors and work towards those goals in order to obtain the specified compensation. In order to qualify for such increased compensation, the agent must also make certain “hurdles” or minimum levels of performance in their overall satisfaction score and schedule compliance. This ensures that agents who are working at the proper levels of quality and productivity are eligible for the increased compensation.

The STARS tools provide a variety of real time graphs to agents and their managers and coaches, that show the agent's individual performance along the various objective metrics described above, along with the performance of the agent's cohorts. The present invention is not limited to the STARS interface, but includes any interface by which agents can measure and model their performance and its relationship to their compensation.

Another aspect of the invention includes identifying the relevant cohorts in which each agent is to be placed. Proper identification of cohorts is useful in order to ensure that agents are being evaluated and ranked against other agents operating under similar conditions (e.g., handling similar types of calls).

The present invention also includes the system architecture for supporting the operation STARS. In one embodiment, the system architecture includes various databases for tracking calls, schedule compliance, transfer compliance, contact resolution and other data from which the performance metrics are determined; a call management system (such as an automated call distributor) for providing the underlying call management capabilities, such as transferring calls, routing calls, and the like; an automated survey system for taking customer surveys and recording results and data for determining measures of agent performance; employee database for storing agent employee information such as hourly pay rate, work schedules, and the like; data marts into which data from the various database are extracted, transformed and loaded, and the corresponding ETL processes and procedures. The present invention also is embodied in computer readable software products and processes, user interfaces, and methodologies.

### BRIEF DESCRIPTION OF THE DRAWINGS

FIG. 1 is an illustration of a user interface for software tool that shows performance and variable compensation information provided to an agent according to one embodiment of the present invention.

FIG. 2 is a block diagram that illustrates a data system for collecting and processing the data used in the variable compensation system prior to the data being presented to an agent as shown in FIG. 1.

### DETAILED DESCRIPTION OF THE PREFERRED EMBODIMENTS

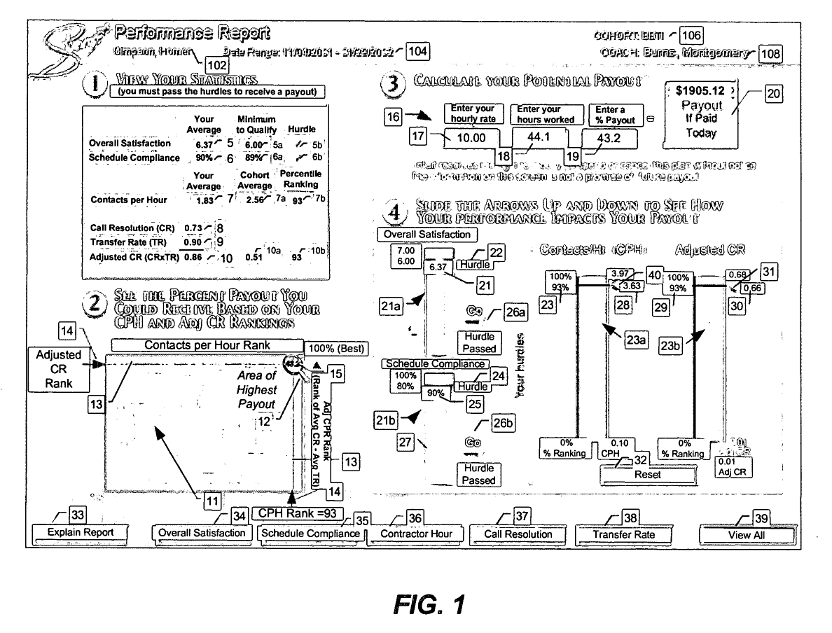

FIG. 1 is an illustration of a user interface 100 of a software tool that shows performance and variable compensation information provided to a customer service agent according to one embodiment of the present invention. The software tool operates on a computer system used by the customer service agent for call handling, account access, call management, and other tasks related to their duties. It assumed that at least some of each agent's compensation is variable; an agent may, but need not, also receive fixed compensation (e.g., hourly pay) in addition to the variable compensation. The variable compensation provided to the agent varies with the performance of the agent, with better performing agents receiving more variable compensation. Ideally, this motivates the agent to perform better and results in better service to customers. The interface 100 of FIG. 1 is one aspect of a software based tool, herein known as the “STARS” tool, that provides agents with real time information about their performance in a manner that shows the relationship between their objective performance factors and their variable compensation, and that allows them to model or estimate potential compensation based on specific, measurable changes in such performance. The interface 100 provides agents with a large amount of information about their performance, and thereby facilitates them to set and achieve performance goals. The agents' individual and aggregate performance improvements in turns results in higher customer satisfaction.

As seen in FIG. 1, the STARS interface 100 displays the name 102 of the agent for which information is being displayed, the range of dates 104 for which the information is relevant, the cohort 106 to which the agent belongs, and the coach 108 to whom the agent reports. A cohort is a group that receives common data, uses one or more common processes, has common characteristics or attributes, in a way that can be distinguished from other groups. The difference between a given cohort and another cohort changes the given cohort's opportunity to perform with respect to measured data in comparison with another cohort. Different cohorts are useful, for example, when one set of agents handle a different call type or a different product type than other groups of agents. Each agent is part of an assigned cohort. A coach's name 108 is also displayed. This coach works with the agent to improve the agent's performance.

The interface 100 also displays information relevant to the performance of the agent, including overall customer satisfaction score 5, the agent's schedule compliance score 6, the agent's contacts per hour 7, a call resolution score 8, a transfer rate 9, and an adjusted call resolution score 10.

The overall customer satisfaction score 5 is taken from data obtained from customers in one embodiment. This data may be obtained using customer surveys. Customers are asked how satisfied they were with the service provided by a particular customer service agent. In one embodiment, the agent is rated by the customer on a scale of 1 to 7, with 7 being the best (though other scales can be used). The displayed overall customer satisfaction score 5 is the average score given to the agent by the customers for a relevant date range. A minimum overall satisfaction score 5a is also displayed in one embodiment. The agent becomes eligible for the variable compensation rewards when that agent's overall satisfaction score 5 is at or above the minimum overall satisfaction score 5a. In the illustrated embodiment, the interface 100 also has a visual indicator 21 that shows whether the agent has met the minimum overall satisfaction score 5a.

The schedule compliance score 6 is calculated by dividing the amount of time the agent is logged into a phone by the amount of time the agent is scheduled to be logged into a phone. In one embodiment, the amount of time the agent is logged into a phone only includes time that the agent is scheduled to be logged and is logged on, and does not include time the agent is logged on but is not scheduled. A minimum schedule compliance score 6a is also displayed in one embodiment. The agent becomes eligible for the variable compensation rewards when that agent's schedule compliance score 6 is at or above the minimum schedule compliance score 6a. In the illustrated embodiment, the interface 100 also has a visual indicator 25 that shows whether the agent has met the minimum schedule compliance score 6a.

The agent's contacts per hour 7 is calculated by dividing the number of calls the agent took by the number of hours the agent worked. In one embodiment, the screen 100 also shows the average contacts per hour 7a for the agent's cohort. The screen 100 also shows a percentile ranking 7b of the agent within the cohort for contacts per hour. By comparing her contacts per hour 7 with her cohort's average contacts per hour 7a and reviewing her own percentile ranking 7b, the agent is able to determine how she are performing in comparison with the cohort and whether she needs to improve her contacts per hour rate. This also gives coaches information about which agents need attention, help, and/or further training to improve their performance.

The agent's call resolution score 8 indicates how often the customers that call the agent feel that the question or the problem they presented to the agent was resolved. The score is calculated by determining the fraction of calls resolved versus the total number of calls. In one embodiment, the information from which the score is calculated is gained from surveying customers after the completion of their call with the agent.

The transfer rate 9 indicates how often the agent transfers calls to a survey. The survey is what is used to determine the call resolution score 8 and the overall satisfaction score 5. The transfer rate 9 is calculated by dividing the number of calls that were transferred by the number of calls that should have been transferred, which in one embodiment is all calls. In one embodiment, agents are supposed to transfer callers so that the callers may be surveyed. The agent transfers the callers after the agent has helped the callers. These surveys provide the data used to measure such scores as the overall customer satisfaction score 6 and the call resolution score 8.

The adjusted call resolution score 10 is a score that reflects the call resolution score 8 as adjusted by the transfer rate 9. In one embodiment, calls that are not transferred are treated as unresolved. This removes incentive for an agent to avoid transferring calls that did not go well. Thus, the adjusted call resolution score 10 is calculated by multiplying the call resolution score 8 by the transfer rate 9. For example, if the agent's call resolution score 8 is 73% and the transfer rate 9 is 90%, that agent's adjusted call resolution score 10 would be 0.66. The screen 100 also shows the average adjusted call resolution score 10a for the agent's cohort, and the percentile ranking 10b of the agent within the cohort for adjusted call resolution score. By comparing the agent's adjusted call resolution score 10 with the cohort's adjusted call resolution score 10a and reviewing the agent's percentile ranking 10b, the agent is able to determine how she is performing in comparison with her cohort and whether she needs to improve her adjusted call resolution score 10. This also gives coaches information about which agents need attention, help, and/or further training to improve their performance.

In one embodiment, a payout grid 11, which is displayed on the screen 100, is used to calculate and display how much the agent will earn in variable compensation, based on the performance of the agent. In one embodiment, the payout grid 11 is a two dimensional grid, with an agent's percentile 7b in contacts per hour along the horizontal axis and an agent's percentile 10b in adjusted call resolution along the vertical axis. The payout grid 11 has a maximum payout, paid to an agent who is at the 99th percentile in both contacts per hour and adjusted call resolution. The payouts in the payout grid 11 scale down from the maximum payout as either or both of the contacts per hour or adjusted call resolution percentiles decrease. Additionally, if the percentiles for contacts per hour and adjusted call resolution are balanced, the payout is more than if one percentile is high and the other low.

In one embodiment, the screen 100 shows interactive lines 13 and arrows 14, each of which the agent may manipulate along the axes to determine variable compensation for varying percentile levels of contacts per hour 7b and adjusted call resolution 10b. At the intersection of a line 13 along a contacts per hour percentile and a line 13 along an adjusted call resolution percentile is a variable compensation payout 15. When the agent first views the screen 100, the payout 15 indicated by the lines 13 is the payout for that agent's current performance level. The agent may also move an interactive magnifying glass 12 or other icon within the payout grid 11 to find the payout at various combinations of percentiles of contacts per hour 7b and adjusted call resolution 10b. In one embodiment, the payout 15 is a percentage, which indicates what percentage of that agent's fixed compensation will be also paid to the agent as variable compensation. In the example shown in FIG. 1, the agent's current adjusted call resolution percentile is the 93^{rd} percentile, and the agent's contacts per hour percentile is also the 93^{rd} percentile, the grid 11 shows that she will receive 43.2% of her fixed compensation as a variable compensation amount, that is an extra “bonus” for this level of performance. In one embodiment, the payouts are largest where both percentiles for contacts per hour and adjusted call resolution are large. In general if one percentile is high and the other is low, the payouts are relatively small. This incentivizes the agent to increase both her adjusted call resolution rank 10b and her contacts per hour rank 7b, rather than merely concentrating on one of these factors.

The screen 100 also displays a calculator 16 that allows computation of the dollar amount that would be paid to the agent for a selected payout 15. The hourly rate 17 at which the agent is paid is displayed on the screen 100, as is the number of hours 18 that the agent works in a given pay period, and a payout percentage 19 (which is initially set to the payout percentage 15 from the grid 11). A payout value 20 is also displayed. In one embodiment, the payout value 20 initially displayed is the payout that corresponds to the agent's current performance. As the example of FIG. 1 indicates, the agent would receive a payout (e.g. a bonus) of $1905.12 if paid out on that day, in addition to her fixed compensation $4,410 (from her hourly wage 17 and hours worked 18), which is a sizeable bonus amount. If the agent moves the interactive lines 13, arrows 14, or magnifying glass 12 to result in other payouts 15 from the payout grid 11, the displayed payout value 20 is automatically updated to show the resulting payout 20 based on the payout grid 122. Other actions by the agent may also cause the displayed payout value 20 to be automatically updated. As any of the hourly rate 17, the number of hours 18, or the payout percent 19 is changed, the payout amount 20 is automatically recalculated and displayed. Thus, as an agent selects different payouts 15 from the payout grid 11, the agent can see how the payout amount 20 the agent would receive also changes. This lets the agent establish personal goals in terms of desired payout amounts 20, and thus the performance goals of adjusted call resolution rank 10b and contacts per hour rank 7b needed to achieve such payout.

In one embodiment, the screen 100 also shows a graphical indication of the agent's performance, which is also interactive. There are two graphs 21a, 21b that deal with whether the agent's performance is adequate to allow inclusion in the variable compensation program. One graph is an overall satisfaction graph 21a, and shows the minimum overall customer satisfaction score (“hurdle”) 22 needed and the agent's overall customer satisfaction score 21 (which has the same value as score 5). If the agent's overall customer satisfaction 21 meets the minimum customer satisfaction score 22, an icon 26a will show a “go” message, such as an arrow. If the minimum customer satisfaction score 22 is not met, the icon 26a will show a “stop” message, such as a stop sign.

A second graph is a schedule compliance graph 21b, and shows the minimum schedule compliance score 24 needed and the agent's schedule compliance score 25 (which is the same as score 6). If the agent's schedule compliance score 25 meets the minimum schedule compliance score 24, an icon 26b will show a “go” message, such as an arrow. If the minimum schedule compliance score 24 is not met, the icon 26b will show a “stop” message, such as a stop sign. These graphs 21a, 21b allow the agent to easily see if they have met the requirements for inclusion in the variable compensation program.

There are also two graphs that indicate the level of the agent's performance in relation to that agent's cohort. The first is a contacts per hour graph 23a. On the left side of this graph 23a is a percentile value 23 that indicates the agent's performance level in comparison to the cohort (initially same as percentile rank 7b), and on the right side of the graph 40 is displayed the actual contact per hour 28 rate. Additionally, there is an interactive pointer 40 with a line. Initially, the pointer 40 show the contacts per hour 7 of the agent. The agent may also move the pointer 40 up or down to different percentiles and raw numbers. When the agent moves the pointer 40 and line, the displayed payout value 20 is automatically recalculated to reflect what the payout would be for the new contacts per hour percentile or rate shown in the graph 23a. This allows the agent to see the effect of increasing or decreasing their contacts per hour will have on that agent's payout dollar amount 20.

There is also an adjusted call resolution graph 23b. On the left side of this graph 23b is a percentile 29 that indicates agent's performance level in comparison to the cohort (initially the value is the same as adjusted call resolution percentile 10b). On the right side of the graph is displayed a raw actual adjusted call resolution score 30. Additionally, there is an interactive pointer 31. Initially, the pointer 31 shows the adjusted call resolution score 30 of the agent. The agent may also move the pointer 31 up or down to different percentiles 29 and raw scores 30. In response, the displayed payout value 20 is automatically recalculated to reflect what the payout 20 would be for the new adjusted call resolution score percentile shown in the graph 23b. This allows the agent to see the effect of increasing or decreasing their adjusted call resolution score 10 will have on that agent's payout dollar amount 20.

Additionally, there is a reset button 32. This reset button 32 allows the agent to reset the graphs 23a, 23b and payout dollar amount 20 to their current actual values after the agent has moved the interactive pointers 40, 31.

There are buttons at the bottom of the screen 100 that may be used to access additional information. An “Explain Report” button 33 provides causes the display of a window with information that explains the data provided in the screen 100. An “Overall Satisfaction” button 34 causes the display a window with an explanation of the agent's performance in relation to the overall customer satisfaction score 5. A “Schedule Compliance” button 35 causes the display of a window with an explanation of the agent's performance in relation to the agent's schedule compliance score 6. A “Contacts Per Hour” button 36 causes the display of a window with an explanation of the agent's performance in relation to the agent's contacts per hour 7. A “Call Resolution” button 37 causes the display of a window with an explanation of the agent's performance in relation to the agent's call resolution score 8. A “Transfer Rate” button 38 causes the display a window with an explanation of the agent's performance in relation to the agent's transfer rate 9. Finally, a “View All” button 39 causes the display of a window with explanations of the agent's performance in relation to the agent's overall customer satisfaction score 5, the agent's schedule compliance score 6, the agent's contacts per hour 7, the agent's call resolution score 8, and the agent's transfer rate 9.

There are several benefits to the variable compensation system described above. Because agents can view their variable compensation payouts in real time, and see how the payout would differ based on different performance by the agents, the agent will be better motivated to achieve performance goals. Further, because cohorts are defined and agents are ranked within cohorts based on percentiles, the capability of different aspects the customer service system can be monitored. Particularly high-ranking agents can be identified and monitored to determine what techniques they use to perform well. Less high-ranking agents can be easily identified and coached with identified successful techniques to perform better.

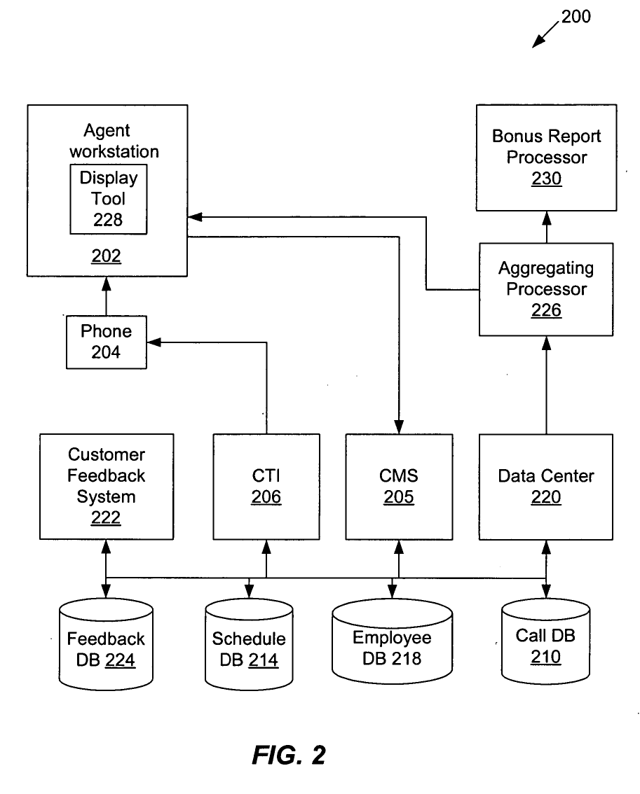

FIG. 2 is a block diagram that illustrates a data system 200 for collecting and processing the data used in the variable compensation system prior to the data being presented to an agent as shown in FIG. 1. In one embodiment, five data types are collected: (1) overall customer satisfaction, (2) call resolution, (3) transfer rate, (4) calls per hour, and (5) schedule compliance. This data is continually collected so that the information presented to the agent as shown in FIG. 1 is substantially real time data.

The data system 200 includes an agent workstation 202, which interfaces with a phone 204. The workstation 202 provides common telephony functions, in conjunction with a computer telephony integration (CTI) system 203 as is normally found in call centers, and a call management system (CMS) 205. The agent logs into the agent workstation 202 and uses the phone 204 of the agent workstation 202 to talk to customers. The CMS 205 keeps track of when the agent is logged in to the agent workstation 202, when the agent is on a call helping a customer, how many calls (“contacts”) the agent receives. The CTI 203 tracks each transfer of a call, including whether calls are transferred to the customer feedback system 222.

Contact information regarding the calls received is sent from the agent workstation 202 where it is collected to a call database 210 where it is stored. This contact information can include the date and time of the call, the identity of the phone 204 that received the call, and other information. Transfer information regarding whether the agent has transferred each call is also sent to the call database 210 where it is stored.

Schedule information regarding whether the agent is complying with their work schedule is sent from the agent workstation 202 where it is collected to a schedule database 214 where this information is stored. This schedule information can include times when the agent has logged into and out of the agent workstation 202. The schedule information may also include other information from the CTI 206 such as how much time in agent spends waiting for a new phone call after finishing a previous phone call.

The data system 200 also includes an employee database 218. This employee database 218 stores information related to each of the agents. This information can include the name of each agent, the cohort to which the agent belongs, the hourly rate of pay each agent receives, the schedule the agent is supposed to follow, and other information.

The data system 200 has a data center 220 connected to the call database 210, the schedule database 214, and the employee database 218. When other parts of the data system 200 request information from any of the call database 210, the schedule database 214, and the employee database 218, the data center 220 retrieves the requested information from the relevant database, puts the information in a form usable by the other part of the data system 200 if necessary, and sends the requested information to the component of the data system 200 that requested the information.

In some embodiments, the data system 200 has separate call, schedule, and employee databases 210, 214, 218 and a separate data center 200. In other embodiments, some or all of these databases 210, 214, 218 and data center 200 are on a single server. Other components of the data system 200 may also be on that server.

If the agent transfers the call, the call is sent to the customer feedback system 222, and the CTI 206 tracks this transfer. The customer feedback system 222 gathers information from the customer about the performance of the agent. In one embodiment, the customer feedback system 222 collects information by prompting the customer with questions, such as whether the customer's question was answered, how satisfied overall the customer was with the agent's performance, and other questions. The customer feedback system 222 may be automated, where the customer enters feedback using such devices as buttons on a touchtone phone, or the customer may speak to the customer feedback system 222 which has voice recognition capability. Alternatively, the customer may speak to another human customer service representative responsible for collecting feedback from customers.

The customer feedback system 222 is connected to a feedback database 224. The feedback information gained from the customer feedback system 222 is sent to the feedback database 224 where it is stored. In one embodiment, when the call is sent from the agent workstation 202 to the customer feedback system 222, information about the agent that handled the call is also sent to the customer feedback system 222. This information is stored with the feedback information in the feedback database 224, so that the feedback information is linked to the agent that handled the call that generated the feedback information.

The data system 200 includes an aggregating processor 226. This aggregating processor 226 communicates with the feedback database 224 so that it may request and receive feedback information. The aggregating processor 226 also communicates with the data center 220 so that the aggregating processor 226 may request and receive information from the call database 210, the schedule database 214, and the employee database 218. The aggregating processor 226 may also perform calculations on the information as needed. For example, if the aggregating processor 226 receives information indicating the hours that an agent worked and the number of calls that the agent dealt with, the aggregating processor 226 may perform a calculation to determine the agent's contacts per hour 114. Alternatively, these calculations may be done by other components of the data system 200.

The aggregating processor 226 communicates with the display tool 228 which also execute on the agent workstation 202, and a bonus report processor 230. FIG. 1 shows an example of the output of the display tool 228. As described above with respect to FIG. 1, the display tool 228 provides the agent with the information collected by the data system 200 as well as other information. To display this information, the display tool 228 requests the information from the aggregating processor 226. The aggregating processor 226 in turn requests the desired information from the various databases of the data system 200, and forwards this information to the display tool 228, which then displays the information to the agent or other user as shown in FIG. 1.

When desired, the bonus report processor 230 provides a report to the organization that shows how much money each agent has earned in variable compensation. The payroll department of the organization may then pay each agent the earned variable compensation. When such a bonus report is desired, the bonus report processor 230 requests information from the aggregating processor 226. The aggregating processor 226 in turn requests the desired information from the various databases of the data system 200, and forwards this information to the bonus report processor 230, which then generates a report that shows how much each agent should be paid in variable compensation.

As described above, each agent's variable compensation is determined with respect a cohort that includes the agent. Accordingly, the system 200 creates a number of cohorts, each including a number of agents. Generally, a cohort is defined as a group that routinely receives different input or uses a different process from another group, and where there is a significant change in their opportunity to perform with respect to their metrics. Different inputs to a cohort include handling a different call type, billing type, or product type (e.g., taking specialized calls, handling different products). A different procedure used by a cohort includes the manner in which calls are handled, such as support that is given as part of a maintenance plan versus support that is billed by time. Preferably, a cohort is not distinguished based on employee differences like length of service or family situation (e.g., kids or no kids), even though these differences may have an impact on metrics (length of service could have a positive impact on Call Resolution, while having kids may have a negative impact on Scheduling Compliance). In other embodiments, these factors may be used for cohort definition.

The identification of a cohort is made by testing a suggested cohort against the “general population” cohort including all of the agents. To do the analysis, a potential cohort is extracted from the population of agents, and their rankings on the various performance measures described above are compared with the general population's performance measures. This enables an agent to compare his or her performance against the entire agent population as well. The identification and analysis of cohorts is done generally as follows.

First, data on all performance metrics is obtained for each agent in the suggested cohort from the various databases in the system 200. Agents who did not qualify (DNQ) for variable compensation because their hurdles for Schedule Compliance and for Overall Satisfaction were missed as labeled. When tested, these agent's performance data is not included for their cohort.

The cohort is then tested against the general agent population comparing the normality of the cohort data, and checking for equal variance within the cohort relative to the general population, with the assumption that the cohorts do not have normal distributions for their metrics. Accordingly, variance is preferably tested using the Mann-Whitney for continuous data. In other embodiments where the performance metrics are discrete, the Chi squared (X²) test is used, or the discrete data is made continuous by ranking the data, and then the Mann-Whitney test is applied. The Mann-Whitney test is preferably used for CPH, Schedule Compliance and Transfer Rate data, which are all continuous. The Kruskal-Wallis test, another non-parametric method, tests the hypothesis that several populations have the same continuous distribution, versus the alternative, that measurements tend to be higher in one or more of the populations. The test can be used to test all groups simultaneously on a single metric by labeling each member of a group.

Regardless of the particular variance test used, testing should preferably be done across all cohorts, using all combinations of all the metrics; this is helpful to validate the differences between each cohort. For example, if there are three known or suspected cohorts and five metrics, there will be 15 tests (all combinations of two cohorts selected from two cohorts, and five metrics tested for each combination). For four cohorts and five metrics, there will be thirty tests, based on six combinations of two cohorts selected from four (AB, AC, AD, BC, BD, CD), and five metrics tested for each combination. If a suspected cohort is determined to not vary from the others or the general population, then the cohort is returned to the general population and remaining cohorts are tested again. In one embodiment, this process of testing is automated, for example, using Answer Tree™ from SPSS, Inc.

For data that is not continuous, e.g., Overall Satisfaction (scale of 1 to 7), there should be at least five responses in each category for the test to be valid. If this minimum cannot be reached with the available data, then the responses can be grouped before running the test (group responses 1 with 2, 3 through 5, and 6 with 7).

Small cohorts (e.g., less than 20 agents) may present difficulty in analysis, as a performance difference may appear to be more significant in small cohorts or be identified, or early in a quarter when there is less performance data available. This is because the distribution of variance of a small cohort is not consistent with that of a large group. The spread in payout is less, while the percent of the time that an agent in the small cohort gets a payout will be greater. For example, an agent who is a member of a large group, e.g., 100 members, may only drop to the 96^{th} percentile if his performance metric drop off, where an agent in a small cohort with the same drop in performance will end up in the 60^{th} percentile. In a group of 21 or so, the relative movement within a group is more like a group of 100. Conversely, someone in a small group can take a bigger step up. The greatest impact seen in a small group is when two rankings for a member of the group are significantly different.

Various measures can be taken to address this concern. First, a separate variable compensation matrix can be used for small cohorts. Alternatively, an overall adjustment in base pay can be made for any agent in a small cohort. Third, a determination of the difference between the cohort distributions of small and large cohorts can be made, and then a correction applied so that the compensation spread for small cohort matches the spread for the large group. Fourth, the distribution of a small cohort can be adjusted so that it more closely resembles the distributions of the large group. Finally, the system can be set to not create a separate cohort from any group with 20 or fewer members.

The above testing of cohorts is preferably done once per quarter (or other useful financial period) for established cohorts, and once per month for new cohorts (for the first three months). If a suspected cohort tests significantly different for three months, then it is made an established cohort.

Where a group of agents is assigned to provide customer support for a new product or service, or other new task, it is preferred that this group remain part of the general agent population until it is demonstrated that they should be classified as a separate cohort. A new group should be tested every month, since a difference may dissipate as agents become more familiar with the product. Existing cohorts should be tested every quarter to ensure that the difference is sustained. There could be a change, e.g., a different procedure is implemented that shortens the duration of calls.

Once the cohort is identified by the foregoing tests, then the agents in the cohort are ranked using a percentile ranking system. By using a percentile ranking system, the index is based on size. For example, for a group of 20, there is a spread of five percentiles between members (this does not account for ties). Every agent is in a cohort.

First, agents are ranked within their respective cohort for calls per hour and adjusted call resolution. All rankings are relative to performance, where the 100^{th} percentile the highest calls per hour and adjusted call resolution measures. The particular spread between agents will depend on the cohort size. Using percentile rank shows what percentage of the cohort is performing below each agent.

In the preferred embodiment, percentile rankings of 18 or higher earn variable pay. The 18^{th} percentile is used as the preferred cutoff as reflecting a minimum required level of performance for agents, but still allowing for a small amount of variable compensation, while larger payouts will be earned for hiher performance. In this manner, variable compensation is rewarded as individuals contribute more to the organization.

Once testing is complete, and cohorts identified, fit tests are performed. Fit tests determine how well the payouts fit predictability. This is preferably done with the agents labeled as DNQ's and those agents falling below the 18^{th} percentile eliminated. Hypothesis testing (e.g., Mann Whitney, CHI²) is used to compare agents in each cohort to the general population. This process determines distribution of variance, e.g. for payroll, where the maximum payout opportunity is reduced and the lowest possible payout is increased. In this step, it may become evident that there is an unequal opportunity to earn, whereas earlier testing was performed to determine if there was an unequal opportunity to perform. Accordingly, payouts can be adjusted as necessary to compensate, for example by adding a shift adjustment, or applying an adjustment factor.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. Persons skilled in the art will recognize various equivalent combinations and substitutions for various components shown in the figures. It is therefore intended that the scope of the invention be limited not by this detailed description, but rather by the claims appended hereto.

We claim:

1. A computer implemented method of providing a customer service agent with variable compensation information, wherein the agent earns both fixed compensation and variable compensation for handling customer inquiries, the method comprising:
displaying to the agent a current amount of variable compensation for the agent based on the agent's current performance level in handling customer inquires;
displaying to the agent a graphical user interface adapted to allow the agent to interactively change the agent's performance level; and
displaying to the agent a change in the amount of variable compensation based on the change in the agent's performance level.

2. The method of claim 1, further comprising:
determining the agent's current performance level as a function of customer satisfaction measure of the agent's handling of customer inquiries.

3. The method of claim 1, further comprising:
determining the agent's current performance level as a function of the agent's compliance with a work schedule.

4. The method of claim 1, further comprising:
determining the agent's current performance level as a function of a number of customer inquires handled per time period.

5. The method of claim 1, further comprising:
determining the agent's current performance level as a function of a measure of customer inquires resolved by the agent.

6. The method of claim 1, further comprising:
determining the agent's current performance level as a function of a rate of customer inquires transferred by the agent to a customer satisfaction survey system.

7. The method of claim 1, further comprising:
determining the agent's performance in comparison with other agents in a cohort including the agent.

8. The method of claim 1, further comprising:
displaying to the agent a minimum measure of performance for the agent to be eligible for the variable compensation.

9. The method of claim 1, further comprising:
displaying a payout grid, comprising a plurality of intersections, each intersection corresponding to a combination of a rate of handling customer inquires and a measure of resolved inquires, and associated with a variable payout factor.

10. A computer implemented user interface for providing variable compensation information to agents, the user interface provided by a computer application executing on a computer system, the user interface comprising:
a display window including a current performance measure for the agent, and a current variable compensation amount based on the current performance measure; and
at least one interactive graphical element that is adapted to be directly manipulated by the agent to change the agent's current performance measure, wherein the current variable compensation amount is automatically adjusted in response to the change in the performance measure.

11. The user interface of claim 10, wherein the current performance measure is a function of customer satisfaction measure of the agent's handling of customer inquiries.

12. The user interface of claim 10, wherein the current performance measure is a function of the agent's compliance with a work schedule.

13. The user interface of claim 10, wherein the current performance measure is a function of number of customer inquires handled per time period by the agent.

14. The user interface of claim 10, wherein the current performance measure is a function of a measure of customer inquires resolved by the agent.

15. The user interface of claim 10, wherein the current performance measure is a function of a rate of customer inquires transferred by the agent to a customer satisfaction survey system.

16. The user interface of claim 10, wherein the current performance measure is a function of the agent's performance in comparison with other agents in a cohort including the agent.

17. The user interface of claim 10, wherein the display window further comprises a minimum measure of performance for the agent to be eligible for the variable compensation.

18. The user interface of claim 10, wherein the display window further comprises:
a payout grid, comprising a plurality of intersections, each intersection corresponding to a combination of a rate of handling customer inquires and a measure of resolved inquires, and associated with a variable payout factor, wherein the variable payout factor is used to automatically adjust the variable compensation amount.

19. A computer implemented system for determining variable compensation for call center agents, the system comprising:
a telephone system including telephones to allow call center agents to provide help to customers over the telephones and a workstation adapted for monitoring the call center agents' use of the telephones, the monitor collecting data including when the call center agents are logged on to the telephone system, how many calls the call center agents receive, and whether the calls the call center agents receive are transferred by the call center agents to a customer feedback system;
a customer feedback system for receiving calls transferred by a call center agents, and determining from the customers on the received calls a satisfaction level of the customers;
a call database connected to the telephone system for receiving and storing data indicative of how many calls the call center agents receive and whether the calls the call center agents receive are transferred by the call center agents;
a schedule database connected to the telephone system for receiving and storing data indicative of when the call center agents are logged on to the telephone system;
a feedback database connected to the customer feedback system for receiving and storing data indicative of whether customers inquiries were resolved and the overall satisfaction of the customers for each call center agent;
a processor for receiving information from the call database, the schedule database, and the feedback database and, based on the received information, calculating variable compensation for each call center agent; and
a display tool for receiving the calculated variable compensation for a call center agent and displaying the variable compensation in real time to a call center agent.

20. A computer implemented method for determining variable compensation for a call center agent, the method comprising:
collecting information on the number of customer support telephone calls received by the call center agent;
collecting information on the times that the call center agent works;
collecting customer satisfaction information of customers handled by the call center agent;
calculating, based on the collected information and in response to a received command, a variable compensation amount for the call center agent; and
displaying the calculated variable compensation amount to allow the call center agent to determine the variable compensation.

21. The method of claim 20, wherein calculating, based on the collected information and in response to a received command, a variable compensation amount for the call center agent, further comprises:
determining the variable compensation amount as a function of the customer satisfaction information.

22. The method of claim 20, wherein calculating, based on the collected information and in response to a received command, a variable compensation amount for the call center agent, further comprises:
determining the variable compensation amount as a function the information on the times that the call center agent works.

23. The method of claim 20, wherein calculating, based on the collected information and in response to a received command, a variable compensation amount for the call center agent, further comprises:
determining the variable compensation amount as a function of the information on the number of customer support telephone calls received by the call center agent.

24. The method of claim 20, wherein calculating, based on the collected information and in response to a received command, a variable compensation amount for the call center agent, further comprises:
determining the variable compensation amount as a function of a measure of customer inquires resolved by the agent.

25. The method of claim 20, wherein calculating, based on the collected information and in response to a received command, a variable compensation amount for the call center agent, further comprises:
determining the variable compensation amount as a function of a rate of customer inquires transferred by the agent to a customer satisfaction survey system.

26. The method of claim 20, wherein calculating, based on the collected information and in response to a received command, a variable compensation amount for the call center agent, further comprises:
determining the variable compensation amount as a function a level of performance of the agent in comparison with other agents in a cohort including the agent.
